(19) United States
(12) Patent Application Publication
(10) Pub. No.: US 2011/0076653 A1
(43) Pub. Date: Mar. 31, 2011

(54) Systems and Methods for Semantic Knowledge Assessment, Instruction, and Acquisition

(76) Inventors: Brent Culligan, Tokyo (JP); Takashi Ono, Tokyo (JP); Kiyoshi Nishijima, Tokyo (JP); David Schaufele, Parksville (CA); Guy Cihi, Central (HK); Charles Browne, Tokyo (JP)

(21) Appl. No.: 11/910,737

(22) PCT Filed: Apr. 5, 2006
(86) PCT No.: PCT/IB2006/002673

§ 371 Date: May 1, 2008

Related U.S. Application Data
(60) Provisional application No. 60/668,764, filed on Apr. 5, 2005.

(51) Int. Cl. G09B 19/06; G06F 17/30

(52) U.S. Cl. 434/157; 707/E17.098

(57) ABSTRACT

Systems and methods for semantic knowledge assessment, instruction, and acquisition are disclosed. In one embodiment a computer-implemented method for language instruction includes determining a lexical recognition ability level of a user within a lexicon of a particular language. This method further includes, based on item recognizability, creating a target list of unknown lexical items. The target list can be sorted by ranking the importance of the unknown lexical items within the particular lexicon. The method also includes generating a personal language learning sequence for the user based, at least in part, on the target list.

### CROSS-REFERENCE TO RELATED APPLICATION

This application claims priority to pending U.S. Provisional Application No. 60/668,764, filed Apr. 5, 2005, and incorporated by reference (Attorney Docket No. 581458001US).

### TECHNICAL FIELD

The following disclosure relates generally systems and methods for semantic knowledge assessment and instruction.

### BACKGROUND

The field of linguistics includes numerous pedagogical theories and methods related to language acquisition. Many of the conventional theories and methods are directed to rule-based grammatical concepts or processes. The standard grammar-translation method, for example, focuses on learning the syntax and structure of sentences. This method assumes that once students have sufficiently learned the grammatical rules for constructing sentences, they will be able to slot-in appropriate vocabulary as needed to generate meaningful language. For example, the audiolingual method (based on habit-formation) focuses primarily on syntactic structures, and vocabulary words are taught only as they would occur within the various structures. More recent research has focused on other grammatical features, such as the developmental sequence, the role of input, and/or the role of instruction in language acquisition.

Lexical concepts and vocabulary learning and instructional methods have historically been viewed as ancillary to mainstream language acquisition theories. However, while mainstream linguists remain primarily focused on grammatical concepts and approaches, another small subset of linguistic researchers and practitioners have focused on language acquisition from a predominantly lexical perspective.

Early lexical research, for example, attempted to develop an understanding of the number of words people know. This required defining both (a) what constitutes a word, and (b) what it means to know a word. Based on one predominant definition of what constitutes a word, there are about 180,000 words in the English language. The following chart, for example, outlines the relationship of frequency of English words to the coverage of running text in the Brown Corpus:

RELATIONSHIP OF FREQUENCY OF ENGLISH WORDS TO
COVERAGE OF RUNNING TEXT IN THE BROWN CORPUS

| DIFFERENT WORDS | % OF RUNNING TEXT |
|---|---|
| 86,741 | 100 |
| 43,831 | 99 |
| 5,000 | 89 |
| 3,000 | 85 |
| 2,000 | 81 |
| 100 | 49 |
| 10 | 24 |

As shown in the chart above, about a quarter (24%) of all the words in English text are likely to be one of the 10 most frequent English words. The chart further demonstrates that as words become less frequent, their contribution to the text coverage decreases. In fact, the 100 most frequent English words account for almost half (49%) of all the words in written English text. For example, the most common word in the English language, “the,” occurs about 6 times in every 100 words of general text.

While most research and findings primarily focused on first language acquisition, there are implications for second language acquisition as well. For example, early research suggested that native speakers have vocabularies of well over 150,000 words and, therefore, the direct study of words did not offer a practical route to language acquisition. Later research, however, determined that native vocabularies likely range from only about 10,000 to 20,000 words. Thereafter, the notion that benefits could be derived from the direct study of words gained credibility. Other researchers have looked into which vocabulary words English-as-a-second-language students should learn, and how the vocabulary words might best be ranked in order of importance.

Some conventional lexical systems, for example, include organizing vocabulary words by frequency as to a corpus or sub-domain thereof. A corpus can consist of millions of pages of text of a given language. A sub-domain is a special purpose lexical item subset within a given language (e.g., American road signs, vocabulary and terms used in finance professions, vocabulary and terms used by information technology workers, etc.). Conventional lexical systems rely predominantly on word frequency in a corpus in making determinations as to what constitutes level-appropriate study material for a given language or sub-domain thereof. For example, publishers have issued (a) level-adjusted graded readers that include only the first 1000 most frequent English words from a general corpus, and (b) word list books that present all of several thousand English words that might occur on a typical TOEIC English language proficiency examination.

Conventional lexical systems, however, include a number of drawbacks. One drawback with many conventional systems, for example, is that the published word lists do not take into account words that particular individuals or groups of individuals may already know. As such, the words lists can include many hundreds, if not thousands, of words that a learner is already familiar with and, therefore, the lists are only marginally helpful in language acquisition because there is little or no advantage in studying known words. Rather, it is the study and acquisition of unknown lexical items that is most beneficial to attaining higher levels of communication ability and overall language ability. This same phenomenon holds true for other types of lexical items, for example, sounds, utterances, multi-word-units, idiomatic expressions, images, signs, symbols, multi-symbol-units, programming code, each of which symbolizes, or serves to convey, a meaning within a language or sub-domain thereof.

Another drawback with conventional lexical systems is that there is no way to quickly and accurately identify the specific lexical items within a given language or language sub-domain that are recognizable and/or unrecognizable to an individual. For example, there are many hundreds of high frequency English words that have low probabilities of recognition by individuals, demographic segments, and/or populations. Conversely, there are many hundreds of low frequency English words that have high probabilities of recognition by individuals, demographic segments, and/or populations. Conventional systems, however, cannot identify and separate the recognizable items from the unrecognizable items.

Conventional lexical systems also include a number of other drawbacks. For example, conventional systems generally do not measure and assess (a) the relative importance of each individual's unrecognizable lexical items, and (b) the lexical depth of knowledge of individuals, demographic segments, and/or populations. Further, most conventional systems do not include suitable processes to organize ability-appropriate reading materials based on each individual learner's assessed lexical ability. Additionally, most conventional approaches do not include suitable processes to assess retention ability for newly learned lexical items. Accordingly, there is a need to improve lexical systems and methods for language acquisition and study.

This background section summarizes various existing theories, methods, and systems related to language acquisition and, more specifically, language acquisition from a predominantly lexical perspective. It also includes discussion of insights and observations made by the inventors about prior art lexical systems that are helpful to understanding the subsequently described invention, but that were not necessarily appreciated by persons skilled in the art or disclosed in the prior art. Thus, the inclusion of these insights and observations in this background section, including the discussion of various drawbacks associated with conventional lexical systems, should not be interpreted as an indication that such insights and observations were part of the prior art.

### BRIEF DESCRIPTION OF THE DRAWINGS

FIG. 1 is a block diagram illustrating a language assessment and instruction system for testing, compiling, assessing, and delivering ability-appropriate language instruction material in accordance with an embodiment of the invention.

FIG. 2 is a block diagram illustrating various components of the system of FIG. 1 configured to process a standard recognition ogive by demographic segment using cumulative individual test responses and respondent data in accordance with an embodiment of the invention.

FIG. 3 is a graph illustrating a cumulative ogive of the recognizability of the 6000 most frequent British National Corpus (“BNC”) English words.

FIG. 4 is a block diagram illustrating various components of the system of FIG. 1 configured to assess the lexical ability of an individual in accordance with an embodiment of the invention.

FIG. 5 is a display diagram illustrating particular examples of Yes/No lexical decision questions for establishing the probability of recognition of each lexical item in accordance with an embodiment of the invention.

FIG. 6A is a display diagram illustrating a lexical item depth of knowledge scale with specific aspects of lexical item depth of knowledge in accordance with an embodiment of the invention.

FIG. 6B is a display diagram illustrating several examples of lexical depth of knowledge decision type questions in accordance with an embodiment of the invention.

FIG. 7 is a display diagram illustrating a particular example of a graph and a written description of an individual respondent's score sheet report in accordance with an embodiment of the invention.

FIG. 8A is a scatterplot graph illustrating the probable recognition ability of each of the 6000 most frequent BNC English words.

FIG. 8B is a scatterplot graph illustrating a hypothetical student's estimated vocabulary size in relationship to frequency and word recognizability.

FIG. 8C is a bar chart illustrating the word recognition probability data illustrated in FIG. 8B.

FIG. 8D is a scatterplot graph illustrating the correlation between BNC frequency data and actual assessed BNC word recognition.

FIG. 9 is a block diagram illustrating various components of the system of FIG. 1 configured to prioritize lexical items based on an individual's assessed lexical ability in accordance with one embodiment of the invention.

FIG. 10 is a block diagram illustrating various components of the system of FIG. 1 configured to prepare and deliver ability-appropriate text material based on an individual's assessed lexical ability in accordance with an embodiment of the invention.

FIG. 11A is a display diagram illustrating an example of English language text filtered in accordance with a particular individual's assessed lexical ability in accordance with an embodiment of the invention.

FIG. 11B is a display diagram illustrating the text of FIG. 11A, after further processing in accordance with an embodiment of the invention.

FIG. 11C is a display diagram illustrating the text of FIGS. 11A and 11B after completion of ability-appropriate filtering and editing in accordance with an embodiment of the invention.

FIG. 12 is a block diagram of a basic and suitable computer and database system that may employ aspects of the invention.

FIG. 13A is a block diagram illustrating a simple, yet suitable system in which aspects of the invention may operate in a networked computer environment.

FIG. 13B is a block diagram illustrating an alternative system to that of FIG. 13A.

### DETAILED DESCRIPTION

A. General Overview

The following disclosure is directed generally to systems and methods for testing, compiling, assessing, and delivering ability-appropriate language instruction material. The language training systems described herein can assess an individual's lexical ability in any given language or lexicon (or any given special purpose sub-domain of a language or lexicon) and, using such assessments, establish a pedagogically optimal course of instruction to efficiently and quickly improve the individual's language and communication ability. More specifically, the disclosed systems and methods can provide a quantification of each individual's lexical ability and generate statistically derived lexical recognition ability assessments and depth of knowledge assessments for individuals, demographic segments, and/or populations. The disclosed systems and methods can also generate a personalized language learning sequence of unrecognized lexical items specifically tailored for each individual based on that individual's assessed lexical ability and needs. Thus, the disclosed systems and methods can provide for direct study of lexical items organized by lexical importance and delivered by various passive and interactive means to each individual learner.

The disclosed systems further includes the generation and delivery of various types of personalized language ability reports to users, and the further organization and conveyance of such reports and related data to others. The system can identify and adjust for any significant differences in specific lexical item recognizability between different demographic segments within the same population and, in particular, between different ages. Furthermore, the system can identify and adjust for any significant differences in lexical item recognizability for any given language or sub-domain thereof that exist between the populations of two or more different countries.

The system further includes the reorganization and presentation of text materials (on any given topic) such that the lexicon of the reorganized text will include a pre-determined percentage of lexical items that are unrecognizable to the learner. The inclusion of a limited number of unrecognizable lexical items in running text thus permits a reader to assign meaning to the unrecognized lexical items through their usage in context among known items.

Aspects of the invention can be characterized in a number of different ways. For example, one aspect can include a method for compiling and maintaining the importance of lexical items within a given language corpus or sub-domain thereof. As used herein, the term “importance” can refer to any one or more of the frequency of item occurrence, scale of item consequence, number of item citations, item value, and any other item specific quantifiable variable. Another aspect of the invention can include a method for testing individual users for recognition of a series of select lexical items drawn from among a general language's lexicon, or the lexicon of a language sub-domain. The selected lexical items can include both real lexical items and pseudo-lexical items. Pseudo-lexical items generally appear to be plausible, but do not have meaning in the given language or lexicon. The method can include, for example, displaying the items using an interactive “Yes/No” lexical decision-type question testing process.

Still another aspect of the invention can include a method for displaying lexical items in an interactive sequence such that the first item presented is randomly selected from among items having a predetermined recognizability for the demographic segment to which the user belongs. A suitable algorithmic process can be used to guide the random selection of each subsequent lexical item, from up and down a recognizability scale, until the user has identified as being recognized at least one real lexical item, and also has identified at least one real lexical item as being unrecognized. Pseudo-lexical items can be randomly dispersed within the presentation of real lexical items to control for the individual conjecturing behavior of a user.

Yet another particular aspect of the invention can include a method for storing (e.g., in a database) demographic information for each test respondent and data regarding each respondent's responses and interactions with respect to the lexical item questions presented during the testing process. Another aspect of the invention can include a method for determining (for particular respondents, demographic segments, and populations) the ability to retain newly learned lexical item knowledge. Retention ability can be based on depth of knowledge, time of retention, or other suitable factors.

Further aspects of the invention can include (a) a method for aggregating response data from all respondents and determining a standard recognizability measure for each lexical item as by demographic segment, (b) a method for establishing a cumulative lexical recognition ogive for one or more particular demographic segments or populations, (c) a method for including each individual respondent's demographic data and lexical items recognition response data in a cumulative lexical recognition ogive, (d) a method for determining each respondent's lexical recognition ability along a cumulative lexical recognition ogive and, in this way, determining the corresponding respondent's recognized and unrecognized lexical items.

Another aspect of the invention is directed to a method for testing each respondent's lexical item depth of knowledge using an interactive display of lexical item depth of knowledge questions (e.g., multiple-choice and/or Yes/No decision-type questions). In one embodiment, for example, the first displayed depth of knowledge item is at the estimated level of ability based on the respondent's assessed ability for lexical item recognition. Subsequent depth of knowledge questions are algorithmically selected to provide the maximum amount of information at the estimate of ability. With each response, the maximum likelihood, test information, and standard error of the estimate are recalculated and, accordingly, subsequent depth of knowledge questions can be selected at the revised estimate of ability and presented to the respondent. The process can be repeated until various levels of lexical item depth of knowledge ability at desired levels of accuracy are achieved.

Still another particular aspect of the invention is directed to a method for determining each of the following to generate a pedagogically optimal personal language learning sequence of unrecognized, unfamiliar, and likely to be forgotten lexical items for study by each individual—

(a) lexical item importance within a given corpus, or sub-domain thereof;

(b) a cumulative lexical recognition ogive for a demographic segment or population;

(c) multiple cumulative lexical depth of knowledge ogives for a demographic segment or population;

(d) a cumulative lexical retention ogives for a demographic segment or population;

(e) an individual respondent's lexical recognition ability;

(f) an individual respondent's lexical depth of knowledge ability; and

(g) an individual respondent's lexical retention abilities.

Another aspect of the invention includes a method for interactively exchanging each learner's personal language learning sequence between a suitable database system and any variety of learning programs or computer systems equipped to interface with such database system. Interactive exchange of data between learning programs and the database system can generate revisions and maintenance to the language learning sequence and the database system can repeatedly deliver an updated and current language learning sequence to the connected learning programs or computer systems.

Still another aspect of the invention is directed to a method for generating learning materials including variations of one or more lexical items in a personal language learning sequence for each individual learner via a personalized electronic mail service. The electronic mail service can utilize various pedagogical strategies to assist subscribers to learn and retain knowledge of lexical items. For example, the personalized electronic mail service can request and provide various means for confirmation of subscriber interactions, thereby allowing appropriate updates to be made to the language learning sequence database system.

Yet another aspect of the invention is directed to a method for generating and delivering various ability-appropriate graded-materials including reading, listening and video materials and other level-appropriate contextual language materials. Such ability-appropriate-materials can request and provide various means for confirmation of subscriber interactions, thereby allowing appropriate updates to be made to the language learning sequence stored in a suitable data storage device.

Still yet another aspect of the invention is directed to a method for generating and delivering personalized interactive lexical language learning games. The language learning games, for example, can deliver batches of lexical items and present lexical items as appropriate to the personal language learning sequence. The language learning games can also deliver and present other forms of level-appropriate learning materials. The language learning games can deliver and present lexical items and other level-appropriate learning materials via mobile communication devices, personal computers, portable electronic devices, and/or other suitable electronic devices. The language learning games can utilize various pedagogical strategies and graphical formats to help subscribers rapidly learn and retain knowledge of a large number of lexical items and other level-appropriate learning materials. The language learning games can also include automatic means to acknowledge and record subscriber interactions, thereby allowing appropriate updates to be made to a database system.

Another aspect of the invention is directed to a method for generating and delivering various types of personalized, cumulative, and/or comparative lexical ability reports to individuals, teachers, and/or program administrators. Reported findings can include, for example, (a) graphic and text descriptions of how many total items are Known, (b) how many items in a given corpus or given sub-domain are known/unknown, (c) how many items within different frequency bands of a corpus or given sub-domain are known/unknown, (d) how well lexical items are known by various aspects of depth of knowledge, (e) how rapidly new lexical items are being acquired through interaction with learning programs, (f) how many items remain before a specific ability goal is achieved, (g) estimates of time required to achieve specific ability goals, and (h) comparisons of any aspects of an individual's ability to equivalent aspects of the cumulative ability of a demographic segment or population.

Still another aspect of the invention can include a method for quickly and precisely identifying how many words a user knows, the exact words the user knows, and which words the user needs to learn in order to reach his or her language learning goal. For example, the system can include a lexical engine configured to determine the words each individual knows. In one embodiment, the lexical engine can display a series of words or other lexical items to the user on the screen of a computer or portable electronic device (e.g., cellular phone, PDA, etc.). The user can choose or click “Yes” if he or she recognizes the word or item, or “No” if he or she does not. Based on the responses, the lexical engine can determine the exact words or items a person knows within a given lexicon. The lexical engine can then rank the remaining unknown words in terms of priority to that individual, and these unknown words will become the user's personal target list.

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section. Illustrative descriptions in this patent application generally refer to the English language, however, the systems and methods described herein can be applied equally to any language or semantic knowledge domain.

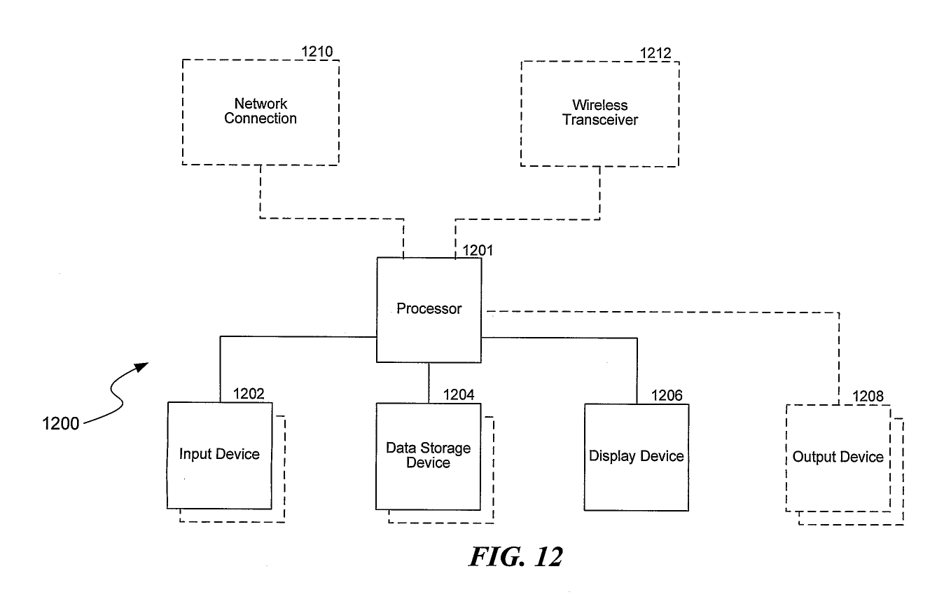

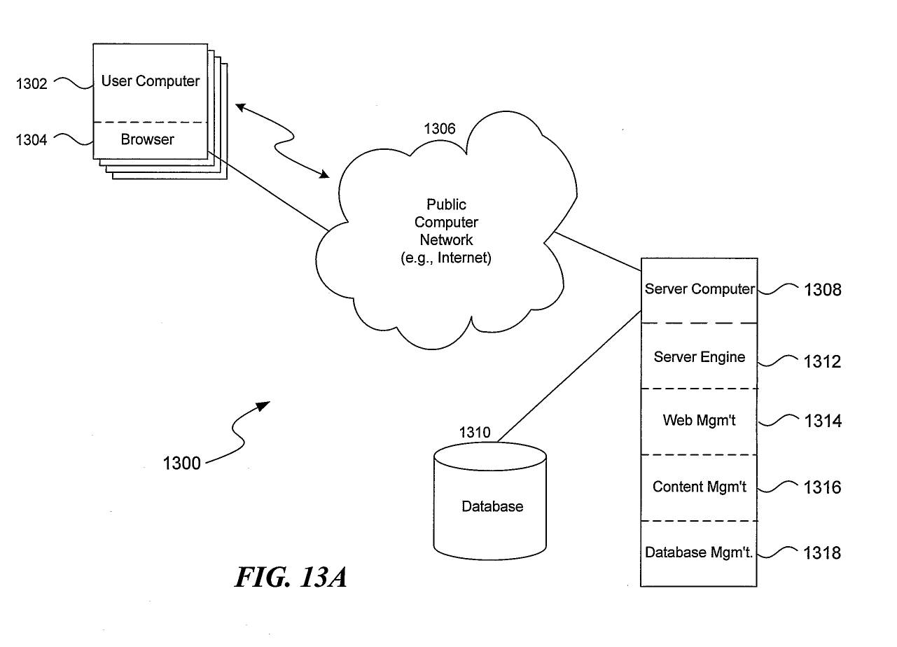

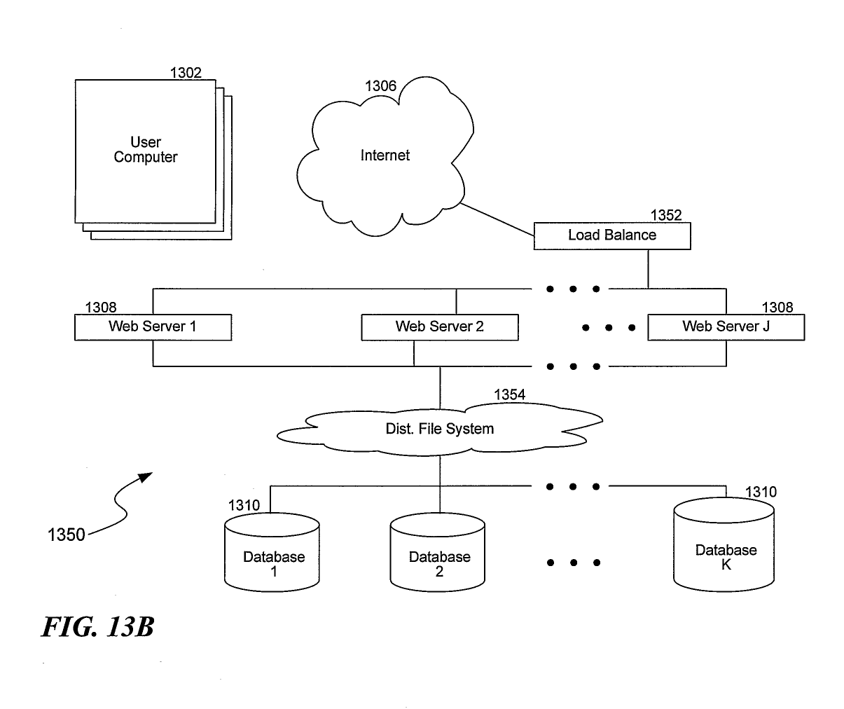

Although not required, aspects and embodiments of the present invention will be described in the general context of computer-executable instructions, such as routines executed by a general-purpose computer (e.g., a server or a personal computer). Examples of such systems are described in more detail below with reference to FIGS. 12-13B.

B. Embodiments of Systems and Methods for Language Knowledge Assessment and Instruction

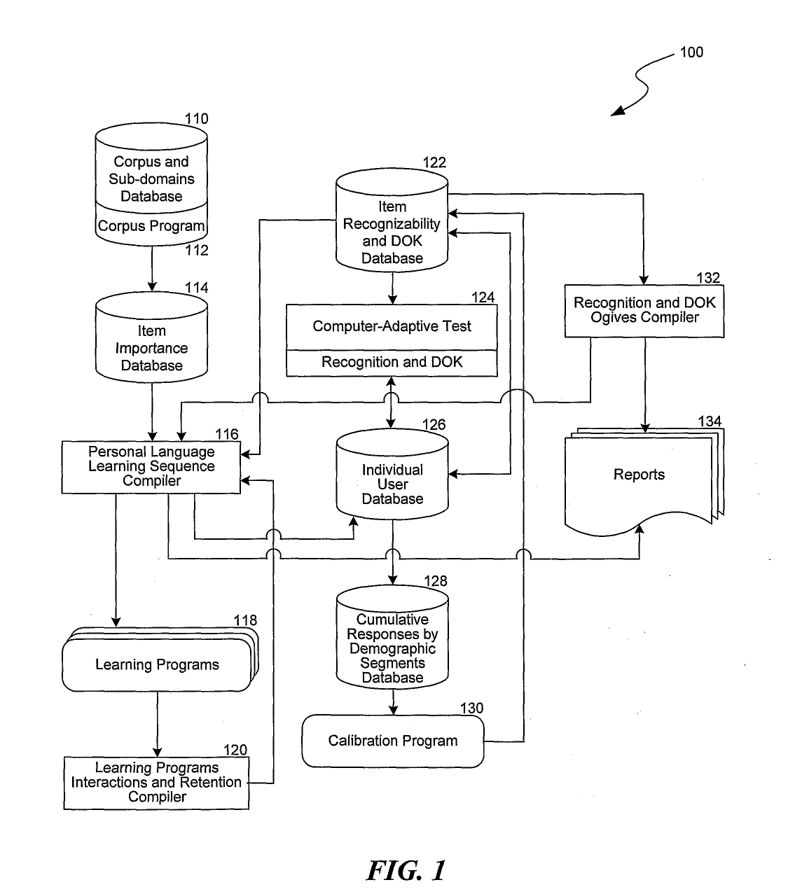

FIG. 1 is a block diagram illustrating a language assessment and instruction system 100 configured in accordance with an embodiment of the invention. The system 100 can include testing components 124, compiling components 122, 126, 128, 130, and 132, assessing components 122, 124, and 132, and delivery components 116 configured to deliver ability-appropriate language instruction material to users.

The system 100 can include one or more corpus and sub-domains databases 110 (only one is shown) configured to store any desired number of corpus and corresponding sub-domains. The system 100 also includes a corpus program or module 112 for compiling importance of lexical item data. More specifically, within each corpus and sub-domain there is a set number of lexical items. The collective total of all lexical items in each corpus or sub-domain is called a lexicon. As used herein, the term “lexical item” refers to any symbol, multisymbol unit, sound, utterance, word, multiword unit, or idiomatic expression that symbolizes a meaning. The term “lexicon” refers to all of the lexical items within a particular language. The lexical items in a given lexicon may be ranked in terms of Importance in the corpus or sub-domain. The corpus program 112, for example, can scan corpora and sub-domains and generate item importance data by corpus and sub-domain. An item importance database 114 can store lexical item importance data by corpus or sub-domain. One advantage of this feature is that lexical items are organized by relative importance with respect to each lexicon and, therefore, it contributes to the most logical and efficient sequencing of unknown and unfamiliar lexical items into a personal language learning sequence for each user.

The system 100 further includes a calibration program or method 130 to estimate lexical item recognizability among a large sample 128, and apply the findings to generate both true ability estimates for each individual respondent and contribute to the generation of a personal language learning sequence 116 of target items for learning. This process can include, for example, using item response theory (“IRT”) to construct a statistical model that establishes the probabilistic relationship between each item and each respondent, demographic segment, and/or population. One advantage of this feature is that it enables the system 100 to precisely determine and report the particular lexical items an individual respondent is not likely to know and, therefore, should study.

The personal language learning sequence compiler 116 is configured to take item importance data from a given corpus or sub-domain thereof, lexical item recognizability data 122, and data from one or more aspects of lexical item depth of knowledge 122, and data from lexical item retention ability 120, and combine them in one or more algorithmic processes to generate and maintain a unique personal language learning sequence of likely unrecognized lexical items. The process is informed by each user's assessed lexical abilities and needs. Accordingly, each user's likely unrecognized yet important lexical items will be prioritized. Additionally, the organization of each user's language learning sequence can be further updated based on his or her ongoing expressions of lexical depth of knowledge and newly learned item retention data.

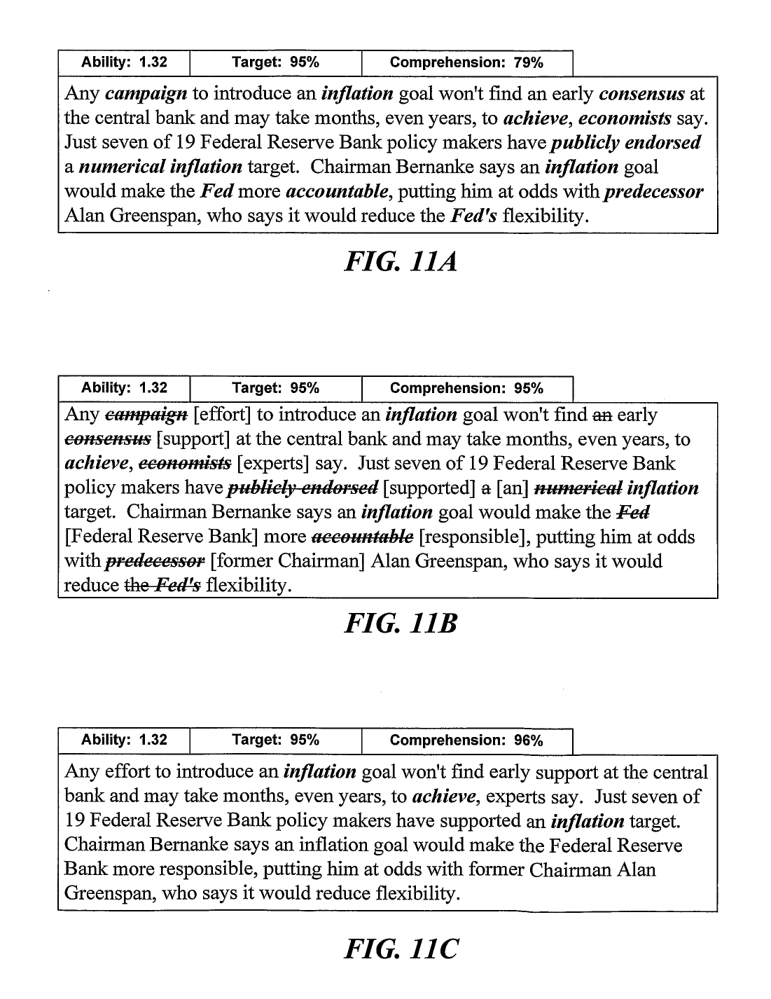

The system 100 also enables interactive exchange of personal language learning sequences 116 between an individual user database 126 and various learning programs 118 and/or other suitable environments. As the learner interacts with one or more of the learning programs 118, the data can be obtained and compiled by an interactions and retention compiler 120. The interactions and retention compiler 120 can inform the learning sequence compiler 116 as progress is made by a particular user to ensure that each user's language learning sequence remains constantly informed and updated as to the user's current lexical ability based on the interactions. More specifically, the interactions and retention compiler 120 can recognize and compile information as to each user's capacity for learning and ability to retain knowledge of newly acquired lexical items over time. In this way, the learning sequence compiler 116 can make adjustments to each user's language learning sequence based on the information received from the interactions and retention compiler 120. Information regarding each user's interaction with learning programs and/or retention of newly learned items can also be stored in the individual user database 126 and made available (as needed) to the learning sequence compiler 116 and/or the reports module 134 (via the compiler 116). The system can also be configured, based on the personal language learning sequences 116, to create and deliver various ability-appropriate materials, in written or aural formats, including materials on topics selected by the learner. This process is described in greater detail below with reference to FIGS. 11A-11C.

The system 100 can also include a computer adaptive test (“CAT”) component 124 as an example of one interface between a user and the system 100. For example, the CAT 124 can be configured to administer tests (e.g., interactive IRT tests) to users via personal computers, mobile phones, PDAs, or using other suitable devices and/or processes. In this way, the CAT 124 can be used to calculate each user's lexical item recognition ability and depth of knowledge abilities. The CAT 124 can also obtain appropriate item recognizability and depth of knowledge data for one or more demographic segments and populations from an item recognizability and DOK database 122.

Each user's ability assessment and demographic details can be stored in the individual user database 126, and each user's raw item response data can be stored in a cumulative response by demographic segments database 128. The cumulative responses database 128 can also be configured to allow the response data from all individual test takers to be periodically aggregated and compiled for use by the calibration program 130. The calibration program 130 can establish recognizability for each lexical item and process related depth of knowledge analysis for populations and demographic segments. The calibration program's findings can be stored in the item recognizability and DOK database 122. The recognition and DOK ogives compiler 132 can be configured to assemble the data from the database 122 into ogives of recognition sorted by population, demographic segment, or another desired element. The ogives compiler 132 can provide each user's relevant ogive to both the reports module 134 and the learning sequence compiler 116.

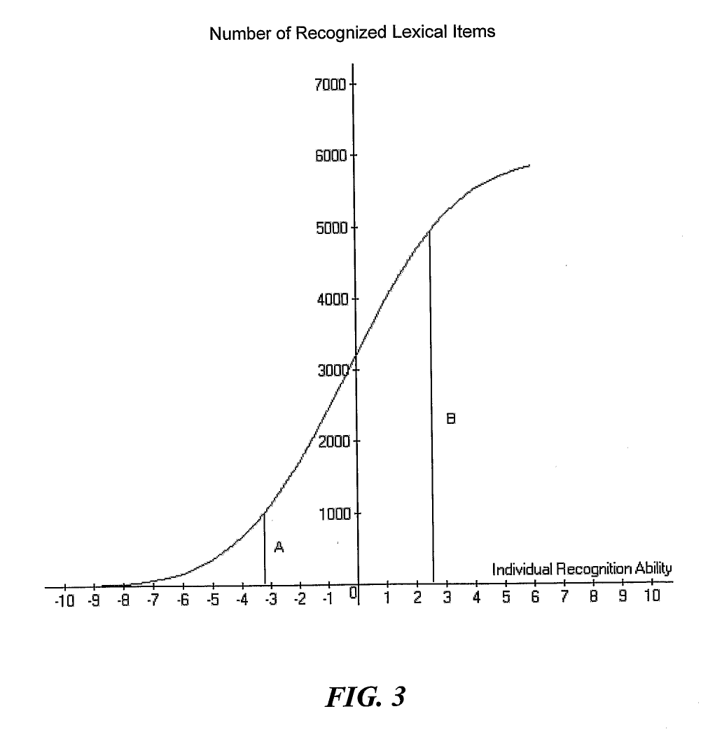

In one embodiment, the individual user database 126 can inform the personal language learning sequence compiler 116 as to the ability of the individual user. The recognition and depth of knowledge ogives compiler 132 can organize recognizability and DOK abilities measures for each demographic segment and population. The ogives compiler 132 can accordingly permit each user's assessment to be made relative to known and unknown words by rank order of recognizability (as described below with respect to FIG. 3). The learning sequence compiler 116 obtains importance of lexical item data from the item importance database 114 for both general language and any desired sub-domains thereof. The learning sequence compiler 116 can rank each user's unknown, unfamiliar, and likely to be forgotten lexical items in terms of priority based on the user's abilities and needs. The most important (but as yet unrecognized) lexical items are prioritized for study by the learning sequence compiler 116.

In one embodiment, the learning sequence compiler 116 can also be configured to provide the user's personal item sequence to various learning programs 118 including, but not limited to, electronic e-mail services, interactive language learning games or activities, and ability-appropriate text materials. Users can interact with various learning games 118 employing suitable pedagogical strategies and formats designed to assist each user study his or her personal language learning sequence. Users may interact with the learning programs via personal computers, mobile phones, PDAs, or using other suitable devices and/or processes.

The reports module 134 can be configured to generate individual graphic and written scores for each user and make them available to the user or other personnel (e.g., teachers, etc.) via personal computers, mobile phones, PDAs, or other suitable devices and/or processes. The reports module 134 can also be configured to generate aggregate-type reports with analysis and/or comparisons of multiple dimensions of lexical ability and learning progress to teachers and/or program administrators. Each report generally includes the number of words known to the user, the location and size of the user's high importance, or high-frequency, word knowledge gaps, and the number of words the user needs to acquire in order to reach their important next lexical goal. Important lexical goals vary from language to language and from sub-domain to sub-domain. In the general English language, for example, it is estimated that knowledge of the first 3000 most frequent words generally permits a person to read typical English reading materials without the assistance of a dictionary. Accordingly, an important goal for users studying English will be to learn the first 3000 most frequent English words. In other embodiments, the reports can include different data and/or have different features.

In the illustrated embodiment, the components of the language training system 100 each include a separate component (e.g., a single database or a single processing component). In other embodiments, however, two or more of the above-described components can be within the same device. In further embodiments, the language training system 100 can include a different number of components and/or the components can have a different arrangement. Additionally, it will be appreciated that one or more of the components of the language training system 100 can have separate utility operating alone or as subsystems within the overall system. For example, various components of the system can be used merely for assessing a user's lexical knowledge. In other embodiments, the components can have other arrangements to perform other functions.

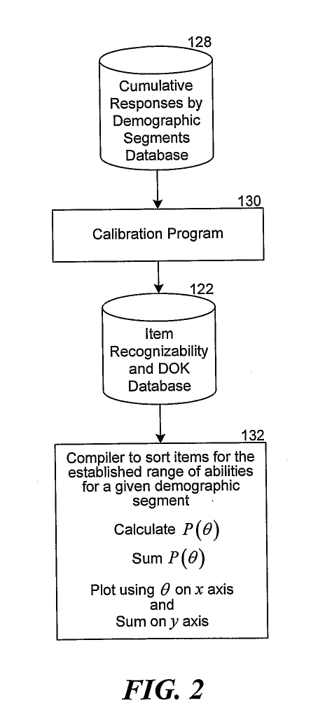

FIG. 2 is a block diagram illustrating various components of the system 100 configured to process a standard recognition ogive by demographic segment using cumulative individual test responses and respondent data in accordance with an embodiment of the invention. More specifically, the cumulative user response database 128 can be analyzed by the lexical item calibration program 130 (utilizing item response theory) at desired intervals. The calibration program 130, for example, can utilize Joint Maximum Likelihood Estimation, a statistical procedure that jointly estimates the maximum likelihood of a vector of item responses. The program begins by making an initial estimate of the respondent's abilities, then treats these estimates as being fixed and estimates the maximum likelihood of the vector of item responses conditioned on the ability estimate to obtain estimates of the recognizability of the lexical items. The results of this step are then treated as fixed and the vector of item responses are then estimated using maximum likelihood conditioned on the lexical item recognizability to obtain new estimates of ability. This process continues until the process converges on set criteria.

In one embodiment, for example, each respondent can respond to a series of items displayed before them in an interactive IRT online test. A suitable number of the lexical items displayed to any one respondent can also have been displayed to other respondents. The calibration program 130 can manage, organize, and periodically compile all respondents' answers as if they were a subset of one overall pool of items to one aggregate test. In one embodiment, respondents' inputs may be organized by any specific demographic segmentation and/or by any language or sub-domain thereof. Because the recognizability measures of each lexical item and the individual ability measures of each respondent are simultaneously estimated by the calibration program 130, all estimates will be on the same scale. Provided the cumulative number of responses to each lexical item is sufficient to stabilize an item's recognizability measure, the system can accurately determine an individual's ability assessment in any specific language sub-domain.

By way of example, in one particular embodiment of the system (and for a demographic segment consisting of 18 year-old Japanese males) the specific recognizability of each lexical item in the Japanese language sub-domain for heavy metal music may be determined. The lexical items for the testing process would be generated through analysis of a corpus sub-domain specifically related to heavy metal music (“HMM”). The sub-domain will be scanned and organized by the corpus program 112, and organized into a lexicon of important items, in this example, ranked by frequency of occurrence within the corpus. As a first step, HMM lexical items will be tested with a beta-test group of approximately 1000 respondents among the target demographic segment. The beta testing can enable initial calibration of the recognizability of HMM lexical items among 18 year-old Japanese males. The test will then be capable of producing provisional estimates of HMM lexical knowledge for each subsequent 18 year-old male respondent. Provisional scores may also be retroactively sent to the initial 1000 beta-test respondents. Thereafter, as the cumulative number of respondents grows, with each subsequent calibration 130 of cumulative responses data 128, the accuracy of the individual ability estimation sharpens. The nature of lexical statistical probabilities is one of diminishing returns. In other words, after a certain point, it generally doesn't matter how many more people respond to each lexical item, the item's measure of recognizability remains generally stable.

The probabilities of a given response are expressed mathematically through a number of different IRT formulas, depending upon the variables and the purpose of the application. In one embodiment, the probability of a random respondent j with ability θⱼ a random item i with recognizability rᵢ correctly is conditioned upon the ability of the respondent and the recognizability of the item. In other words, if a respondent has a high ability in a particular domain, he or she will probably recognize an item having high recognizability to the respondent's demographic segment and population. Conversely, if a respondent has a low ability and the item has low recognizability, the respondent will probably not recognize the item.

In one embodiment, a probability of item recognition can be calculated using the following equation:

$${P}_{i} ( θ ) = \frac{{e}^{( θ - {b}_{i} )}}{1 + {e}^{( θ - {b}_{i} )}} \qquad ( 1 )$$

where Pᵢ(θ) is the probability of a random respondent with ability θ recognizing item i, e is the base of natural logarithms (2.718), θ is the respondent's ability measured in logits, b ᵢ is the un-recognizability parameter of the item measured in logits, and rᵢ is the recognizability parameter or (bᵢ*−1.0) .

The higher the value of the estimate of ability θ, the greater the respondent's ability. The estimate of ability θ can range from −∞<θ<∞ ability. Likewise, the higher the value of the estimate of recognizability rᵢ, the more recognizable the item. Recognizability can range from −∞<b<∞.

A suitable model can be constructed based on one or more versions of the following equation:

$$P ( {U}_{ij} = 1 \vert {b}_{i} {θ}_{j} {γ}_{j} ) = ( {γ}_{j} ) + \frac{1 - {γ}_{j}}{1 + {e}^{D ( {θ}_{j} - {b}_{i} )}} \qquad ( 2 )$$

where e is the constant 2.1718, bᵢ is the un-recognizability parameter, γⱼ is the individual conjecturing behavior of respondent j, θ is the ability level, and D is a scaling factor.

In one embodiment, the method can include comparing the measured recognizability of a lexical item with a mathematical manifestation of the rank of the item based on importance in corpus through one or more algorithmic processes to quantify the relative priority of probabilistically unrecognizable items to each learner.

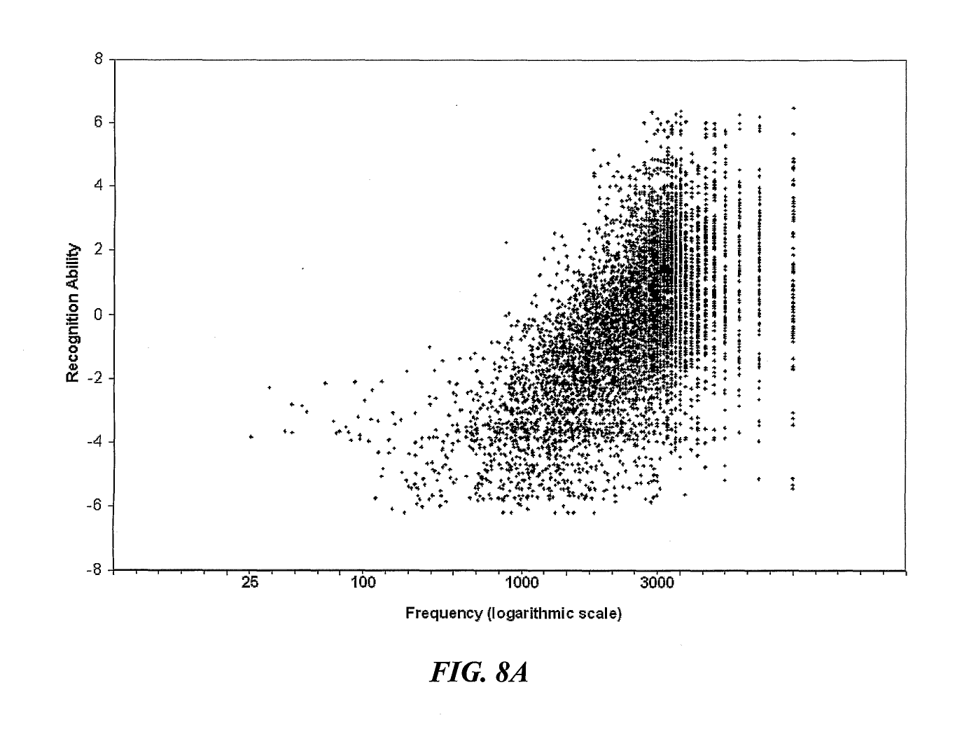

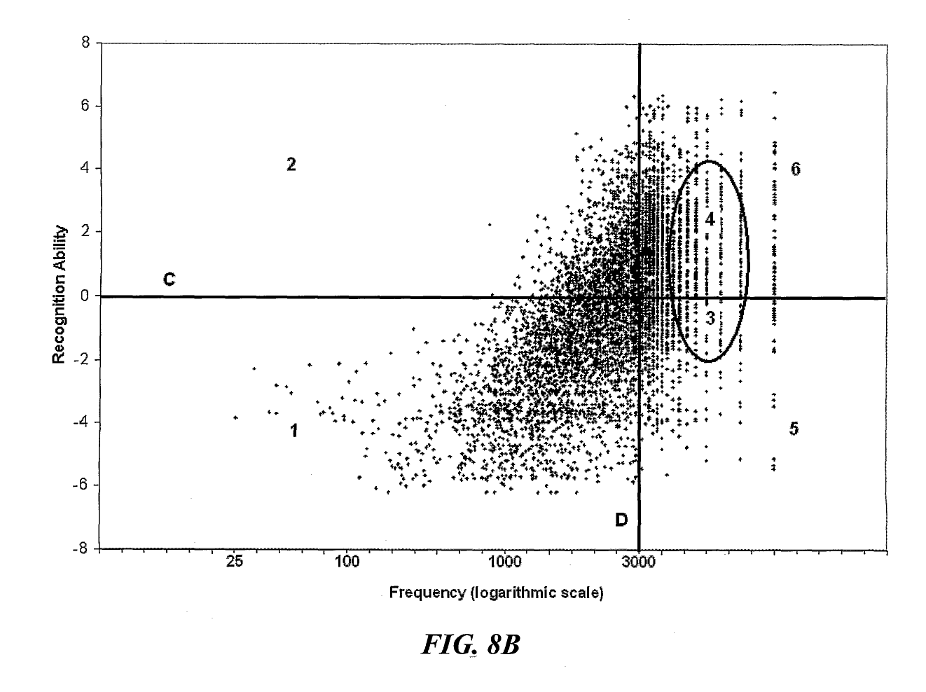

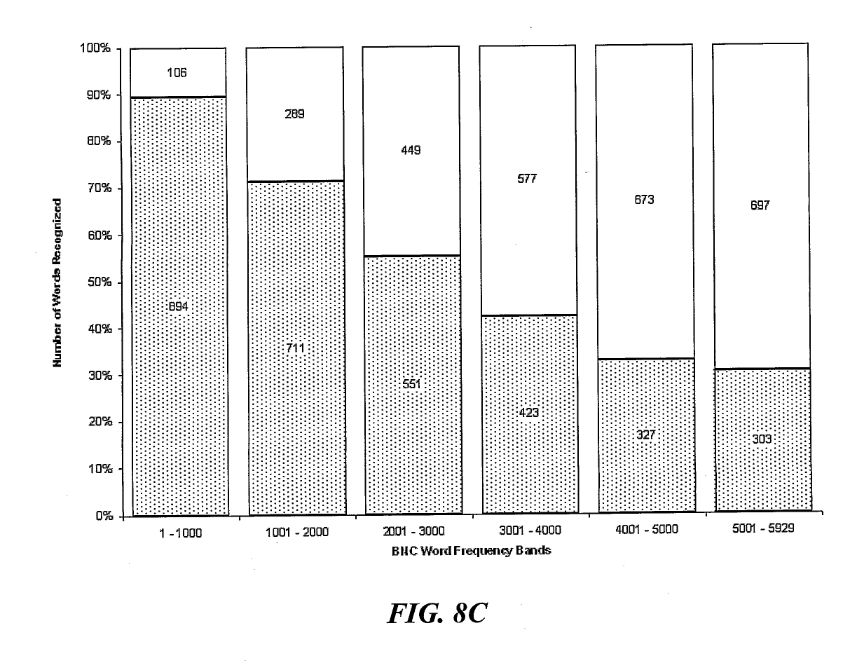

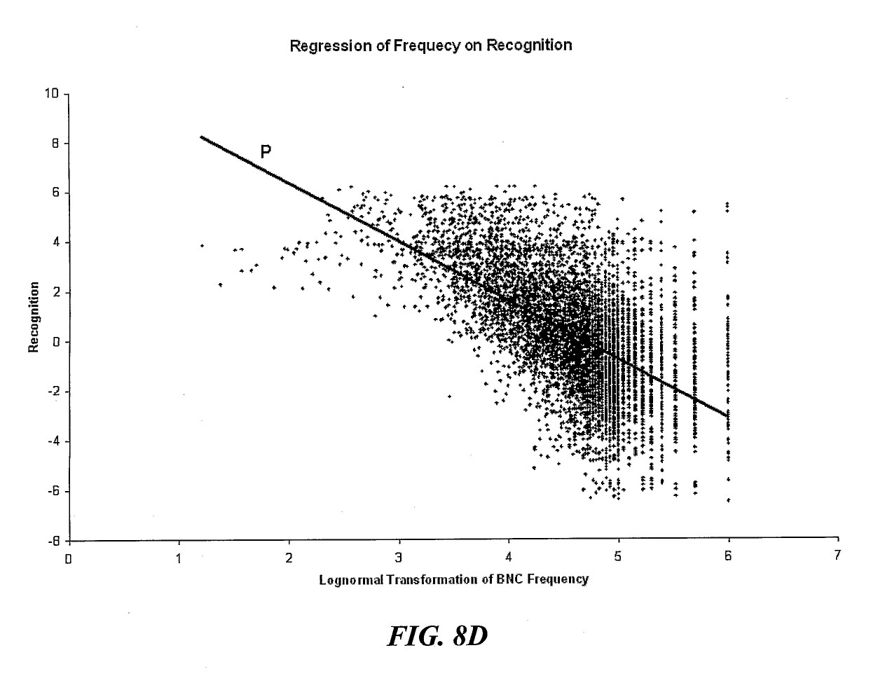

FIG. 3 illustrates a graph of a cumulative ogive of the recognizability of each of 6000 most frequent BNC English words among an age-specific demographic segment within the Japanese population. The words are organized as by recognition to the cumulative respondents, not as by frequency in corpus. Line A illustrates an assessed ability of −3.29 for test respondent A, which indicates that respondent A is probabilistically likely to recognize 1000 of the 6000 words recognizable to this demographic segment. Line B illustrates an assessed ability of +2.63 for test respondent B, which indicates that respondent B is probabilistically likely to recognize 5000 of the 6000 words recognizable to this demographic segment. The data illustrated in FIG. 3 is further described below with respect to FIG. 8.

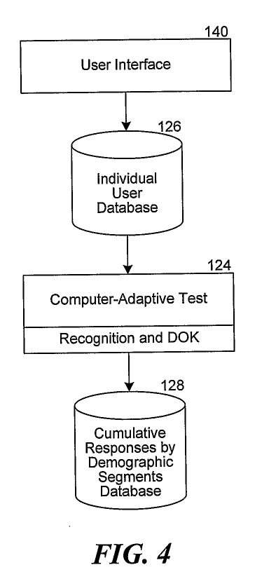

FIG. 4 is a block diagram illustrating various components of the system of FIG. 1 configured to assess the lexical ability of an individual in accordance with an embodiment of the invention. The assessment process can be used, for example, to provide an accurate estimation and reporting of both the total number and the specific lexical items an individual respondent is likely to know within a corpus or sub-domain thereof.

In one embodiment, the user interface 140 can be used to estimate the user's ability by presenting the user with a Yes/No decision-type test. Yes/No tests, also known as lexical decision tasks, ask users to respond yes or no to questions posed about lexical items selected from among a series of real and pseudo lexical items. The system can utilize various aspects of signal detection theory to compare the user's Yes/No responses to real items against Yes/No responses to pseudo-items. The system, through one or more algorithmic processes, calculates the probability of a user making a correct decision, as well as the degree of accuracy to which the user makes each decision.

In one embodiment, the test administers items one by one and, based upon the response pattern of the user, varies the recognizability factor of the items displayed until a desired level of response accuracy has been achieved. Because the test is constantly zeroing in on a user's level based on their correct or incorrect responses, a far fewer number of questions is needed to accurately estimate ability than conventional testing methods.

The accuracy of any measure is associated with the standard error of estimate which is a figure informed by the amount of information that each specific item contributes to the aggregate test results. Equation 3 illustrated below shows the information function for the estimate based on a test, and Equation 4 illustrates the relationship with the standard error of the estimate:

$$I ( θ ) = {\sum }_{i = 1}^{n} \frac{{[ {P}_{i}^{′} ( θ ) ]}^{2}}{{P}_{i} ( θ ) {Q}_{i} ( θ )} \qquad ( 3 )$$

where I(θ) is the information provided by a test of items 1 to n and Pᵢ′(θ) is the derivative of Pᵢ(θ).

$$SE ( θ ) = \frac{1}{\sqrt{I ( θ )}} \qquad ( 4 )$$

where SE(θ) is the standard error of the estimate.

In one embodiment, the system can include computer adaptive testing and the test taker can be presented with lexical items randomly drawn from a database of lexical items and pseudo-lexical items. The first real lexical item is randomly selected from among items having recognizability at the mean for the demographic segment to which the user belongs. Depending on how the user responds, the next real lexical item may be drawn from approximately one standard deviation above or below the mean. Subsequently, one or another valid algorithmic process will be implemented to guide the random selection of lexical items, from up and down on a recognizability scale 122 (FIG. 1), until the user has identified as being recognized at least one real lexical item, and also has identified at least one real lexical item as being unrecognized. Pseudo-lexical items are randomly dispersed within the presentation of real lexical items to control for the individual conjecturing behavior of a user.

The maximum likelihood estimate of the test-taker is calculated using the derivative of the likelihood function, as illustrated in Equation 5 below, as well as the test information function and standard error shown above in Equation 4.

$$L ( {u}_{1} , {u}_{2} , … {u}_{n} \vert θ ) = {\prod }_{j = 1}^{n} {P}_{j}^{{u}_{j}} {Q}_{j}^{1 - {u}_{j}} \qquad ( 5 )$$

where L(u₁, u₂, . . . uₙ|θ) is the likelihood of the vector of responses.

In each instance, a next lexical item is selected so as to give the maximum amount of information at that estimate of ability. Next, the maximum likelihood, test information, and standard error of the estimate are calculated again. This process can be repeated until the desired level of accuracy is achieved and, therefore, the number of lexical items and the amount of time necessary to complete the test are variable.

In one embodiment, a lexical test administered with the CAT 124 can utilize various aspects from the above formulas in order to provide a fast and efficient means of assessing various specific aspects of each learner's lexical depth of knowledge. Students may, for example, also be tested on certain low importance words that may have been identified as false-friends (i.e., words from the mother tongue that are spelled or sound like words in English, but whose usage or meaning in the native language is very different). By employing multiple measures of different aspects of lexical depth of knowledge 124, not only will the recognition assessments described herein be validified through concurrent measurement, but also new and unique forms of depth of knowledge assessment can be made possible.

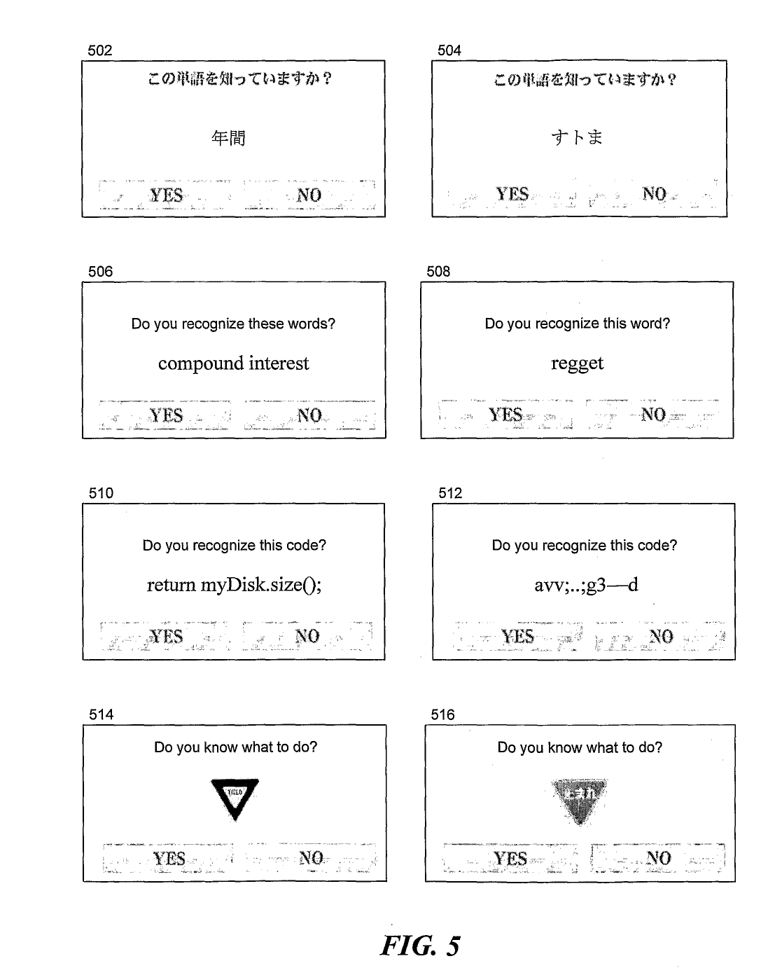

FIG. 5 is a display diagram illustrating particular examples of lexical decision questions for establishing the probability of recognition of each lexical item in accordance with an embodiment of the invention. As demonstrated by the illustrated examples, the systems and methods disclosed herein can be useful for the assessment and instruction for all types of semantic knowledge. In this embodiment, the system provides for individual testing of lexical recognition through online interactive Yes/No lexical decision-type questions. An important part of the assessment process is the inclusion of pseudo-lexical items. Pseudo-lexical items appear plausible but do not have meaning in the given language. By way of example, block 502 describes a lexical Yes/No type decision question displaying a word in the Japanese language as if to a Japanese user, and block 504 illustrates the display of a pseudo-Japanese word as if to a Japanese user. Block 506 illustrates an actual English multi-word-unit, “compound interest,” drawn from a financial sub-domain within the English language, and block 508 describes a pseudo-English word, “regget.” Block 510 describes an expression of Java programming language code, “return myDisk.size( );” and block 512 displays a pseudo-expression of Java code “avv;..;g3-d.” Block 514 describes an actual traffic sign from a sub-domain within the English language, and block 516 illustrates a pseudo-traffic sign within the same domain.

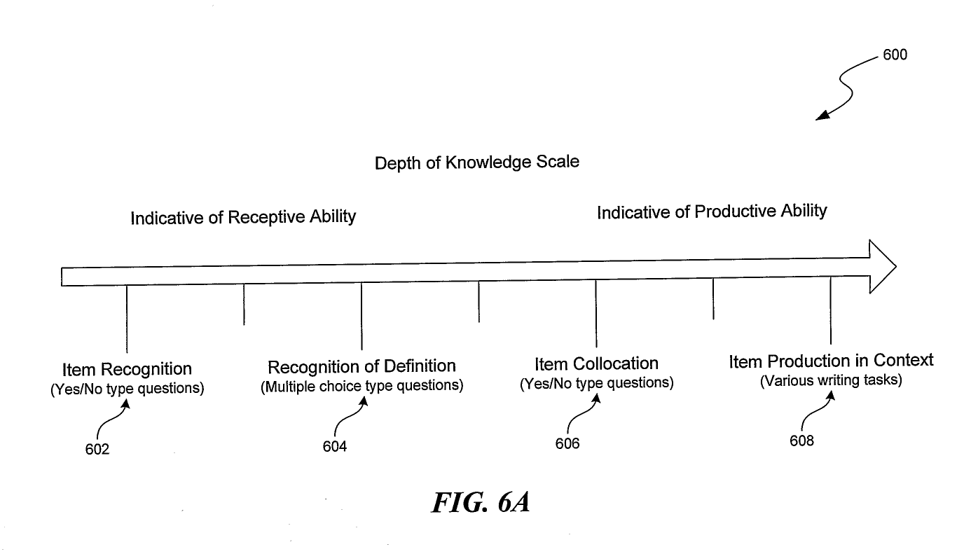

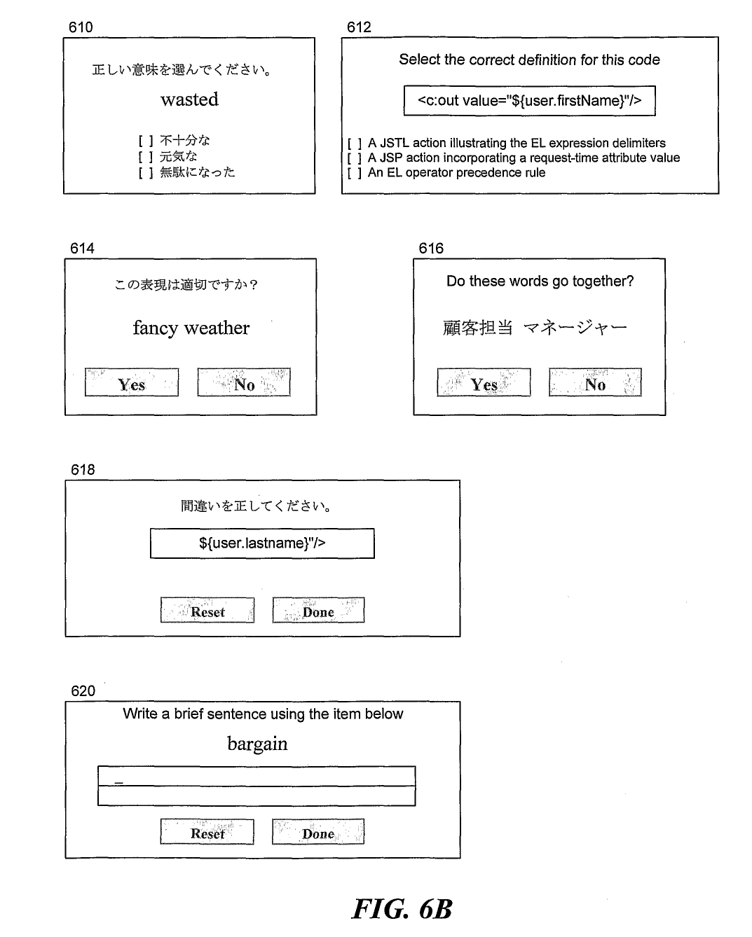

FIG. 6A is a display diagram illustrating a lexical depth of knowledge scale 600. Several aspects of lexical depth of knowledge are shown. Lexical depth of knowledge is shown beginning with recognition 602 and increasing progressively to greater depths of knowledge toward the right side of the scale. Being able to select the correct definition 604 indicates fair grasp of a word's meaning, and correctly judging an item's collocations 606 indicates a deeper understanding. Even deeper levels of understanding, though, are evidenced through productive capability 608 such as writing words in sentences.

FIG. 6B is a display diagram illustrating particular examples of lexical depth of knowledge decision type questions in accordance with an embodiment of the invention. The system provides for individual testing of lexical depth of knowledge through means including multiple-choice decision type questions, and Yes/No lexical decision type questions. The system provides a quantification of lexical depth of knowledge based on multiple aspects of lexical item depth of knowledge on a continuum beginning at receptive knowledge and moving through increasingly deeper levels to productive lexical item knowledge. The illustrated examples of depth of knowledge questions assess different aspects of probable depth of knowledge. An integral part of the process is the inclusion of distracter definitions, and pseudo-lexical collocations. Distracter definitions are plausible but false definitions of lexical items. Pseudo-lexical collocations are plausible but false collocations.

The examples shown in FIG. 6B can be used to ascertain depth of knowledge for three different aspects of lexical depth of knowledge. For example, block 610 illustrates a recognition of definition type question for the English language word “wasted” as it might be presented to a Japanese user. Block 612 illustrates a recognition of definition type question for the Java programming code expression “<c:out value=“${user.firstName}”/>.” One of the three definitions provided is a true definition, while the other two definitions are plausible distracters.

Blocks 614 and 616 illustrate collocation recognition type questions. More specifically, block 614 illustrates the pseudo-collocation “fancy weather” of the English language as it might be presented to a Japanese user, and block 616 illustrates a true collocation in the Japanese language.

Blocks 618 and 620 illustrate two forms of an item-production-in-context task. Block 618 illustrates an item-production-in-context type task asking a Japanese user to correct the error in an expression of Java programming code. Identifying and correcting spelling and punctuation errors are forms of production. Block 620 illustrates a sentence writing task for the English word, “bargain.” Using the word “bargain,” the user would be tasked to write a sentence in the space provided.

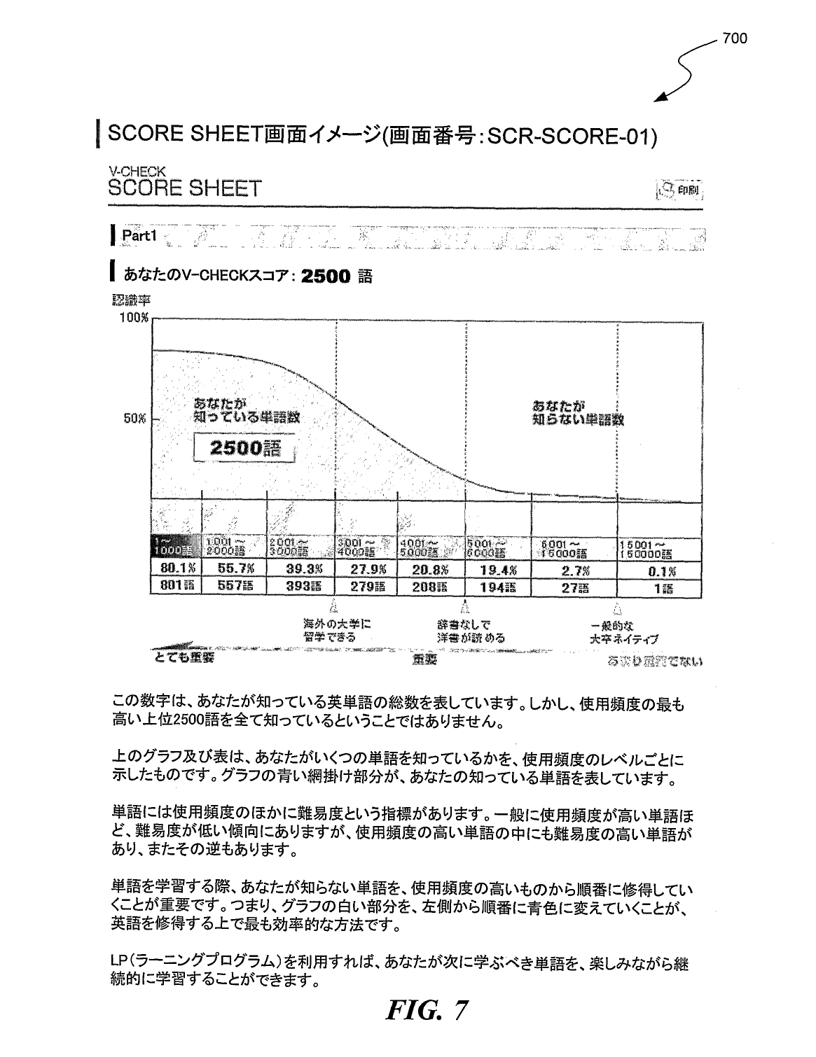

FIG. 7 illustrates an embodiment of a test score sheet 700 for an individual Japanese user who knows about 2500 words. One feature of the score sheet 700 is that it displays an absolute score and ties the score to how many lexical items the individual user knows. Another feature of the score sheet 700 is that the scoring system enables direct comparison with other groups and averages. In this case, the user knows 2500 total English vocabulary words, but just 1751 are among the first 3000 most frequent words. Accordingly, one advantage of score sheet 700 is that it enables users to visualize the significance of their high-frequency word knowledge gaps. In this case, for example, of the 1751 words, the user knows 801 of the 1000 most frequent words in the corpus (i.e., 80.1%), 557 of the second 1000 most frequent words (i.e., 55.7%), and 393 of the third 1000 most frequent English words (i.e., 39.3%).

One objective for the disclosed systems and methods is to assist learners to acquire a meaningful number of the most important lexical items. As discussed previously, knowledge of the first 3000 most frequent English words generally permits a person to read typical materials without the assistance of a dictionary. In this particular example, the learner's goal will be to acquire the 1249 unknown English words among the 3000 most frequent English words. The initial learning sequence can include 199 of the most frequent (but unknown) words. The systems and methods described herein can make accurate lexical assessments, and accurate pace of learning predictions, quantifiable. Furthermore, various embodiments of the system include different types of group ability and progress reports that can be organized for teachers and program administrators. Thus, the system enables comparisons and analysis of multiple dimensions of individual and group lexical ability.

Accurate graphing provides a clear benchmark for learners and teachers to track progress over time. In several embodiments, for example, after a set period of time, a subsequent test can demonstrate that progress has been made. The system can accurately assess and display progress (provided that the learner has made an effort to acquire new words). Additionally, users who take advantage of the system's electronic mail services and/or learning game services can further their progress toward the 3000-word goal.

FIG. 8A is a graph of a scatterplot showing the probable recognizability of each of 6000 most frequent British National Corpus (“BNC”) English words among an age-specific demographic segment within the Japanese population. Each dot point in the illustration indicates one specific word among the 6000 BNC words. Findings displayed were determined through statistical analysis of 4,217 responses to Yes/No decision type lexical item questions by 549 individual users from one age-specific demographic segment within the Japanese population.

FIG. 8B is a scatterplot graph illustrating all specific words among the 6000 BNC words. Each dot point in the scatterplot indicates one specific word. Horizontal line C indicates an assessed recognition ability of 0.0 for an individual user C. Vertical line D is drawn such that 3000 dot points lie on or to the left of line D.

The area labeled 1 encompasses many dot points each representing a specific word among the 3000 most frequent BNC words that are probably recognizable by user C. The farther below user C's 0.0 assessed level of ability any particular dot point lies, the more probable it becomes that user C will recognize the word represented by that dot point. Dot points that lie on the 0.0 assessed ability level of user C, represent the specific words that user C will have a 50/50 probability of recognizing. The area labeled 2 encompasses many dot points each representing a specific word among the 3000 most frequent BNC words that user C is probably not likely to recognize. The farther above user C's 0.0 assessed level of ability that any particular dot point lies, the more probable it is that user C will not recognize the word represented by that dot point.

The oval shape that defines areas 3 and 4 describes an example of a special purpose language sub-domain within the corpus. The area labeled 3 represents the special purpose sub-domain's words that are probabilistically recognizable to user C. The area labeled 4 represents the special purpose sub-domain's words that are probabilistically unrecognizable to user C. The area labeled 5 encompasses dot points, each representing a specific word among the 3001 to 6000 most frequent BNC words that are probably recognizable to user C. The area labeled 6 encompasses dot points, each representing a specific word among the 3001 to 6000 most frequent BNC words that user C is probably not likely to recognize.

FIG. 8C reorganizes the data of FIG. 8B to show user C's specific word recognition within one-thousand-word frequency bands of the BNC. This graph indicates, for example, that user C is likely able to recognize 894 of the first 1000 most frequent BNC words. This finding is important in terms of lexical ability assessment. However, of far greater importance is that the process identifies each of the 106 words, within the first 1000 most frequent BNC words, that are likely unrecognizable to user C.

FIG. 8D reorganizes the data of FIGS. 8A and 8B to permit a comparison of a lognormal transformation of the BNC frequency data versus actual assessed BNC word recognizability. Line P in the scatterplot shows predicted word recognizability based on the regression of word frequency on measured item recognizability. While this regression line shows an absolute correlation between frequency and item recognizability of 0.60, the standard error of 1.92 reveals that word frequency data cannot provide a statistically valid method to determine which lexical items are likely known and which lexical items are likely unknown to an individual user. The illustrations in FIGS. 8B and 8D confirm that lexical item recognizability data, as determined for individual members of a demographic segment of a population, does provide a statistically valid basis for the estimation of each lexical item's probable recognition by each individual user.

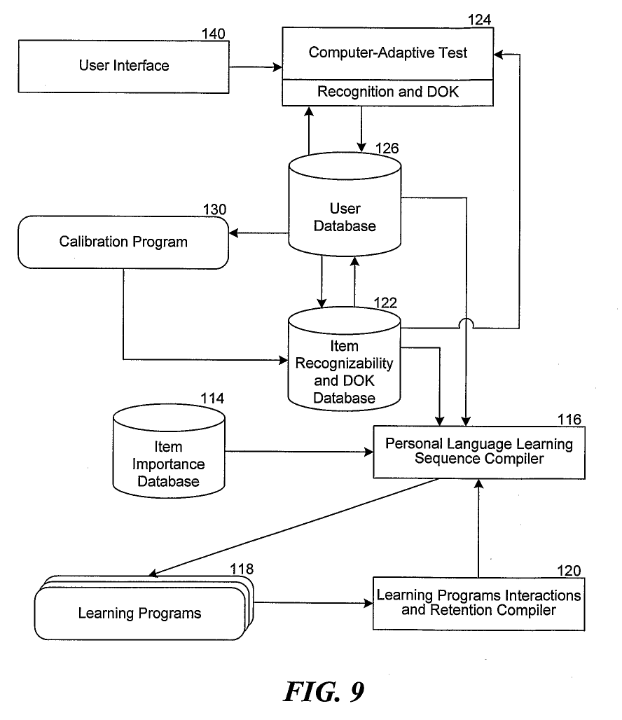

FIG. 9 is a block diagram illustrating various components of the system of FIG. 1 configured to prioritize lexical items based on an individual's assessed language or sub-domain lexical ability in accordance with one embodiment of the invention. For example, various algorithmic processes can calculate (a) each individual's lexical recognition ability 124, (b) lexical depth of knowledge 124, and (c) retention rates 120, together with corpus or sub-domain item importance data 114 (as appropriate) to create an ideal personal lexical learning sequence 116 for study by each learner.

In one embodiment, each learner's personal language learning sequence 116 can be delivered to multiple and various types of learning programs 118. As discussed previously, the system can obtain feedback from the learning programs 118 about the learner's interactions with the learning programs. Feedback received will inform the system, enabling it to reorganize the personal language learning sequence to each learner's current ability and needs assessment. Based on feedback from the learning programs, the system can, for example, retire lexical items, recycle previously retired lexical items, add new lexical items, or modify the aspect of depth of knowledge for a particular lexical item to be presented to the learner.

The system can also include a personalized electronic mail service that delivers one or more lexical items from the personal language learning sequence to individual learners via electronic mail. The personalized electronic mail services can utilize various pedagogical strategies to assist subscribers in learning and retaining knowledge of important new lexical items. The personalized electronic mail services can also provide various means for, and request confirmation of subscriber interactions, thereby allowing appropriate updates to be made to the system's database.

Another aspect of the personalized electronic mail service is that it assists subscribers in learning and retaining knowledge of proper usage of lexical items in context through the creation and delivery of various ability-appropriate materials, including reading, listening and video matter on topics of interest to the subscriber and other forms of ability-appropriate contextual language materials. Such ability-appropriate materials can provide various means for, and request confirmation of subscriber interactions, thereby allowing appropriate updates to be made to the system's database.

The system also provides for generation of personalized interactive language learning games that deliver batches of lexical items and present lexical items in accordance with the subscriber's personal language learning sequence. The personalized interactive language learning games can also deliver and present other forms of ability-appropriate learning materials. The personalized interactive language learning games can be delivered to subscribers via personal computers, mobile phones, mobile communication devices, and/or other suitable electronic devices.

The personalized interactive language learning games can utilize various pedagogical strategies and graphical formats to assist subscribers to more rapidly learn and retain knowledge of a large number of lexical items and other ability-appropriate learning materials. The personalized interactive language learning games can also provide for automatic means to acknowledge and record subscriber interactions, thereby allowing appropriate updates to be made to the system's database and the learner's personal language learning sequence.

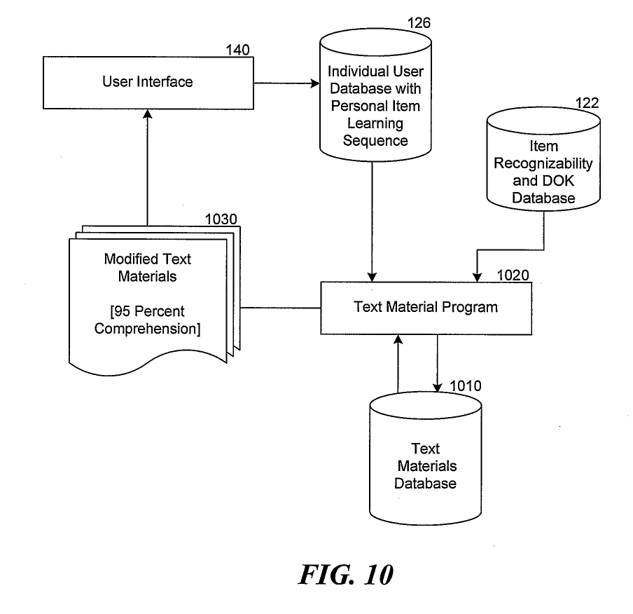

FIG. 10 is a block diagram illustrating various components of the system of FIG. 1 configured to prepare and deliver ability-appropriate text materials based on an individual's assessed lexical ability in accordance with an embodiment of the invention. The process for editing and reconforming any text materials including written, aural or video can be based on each individual's assessed lexical ability. A suitable text material can be drawn from a database of topical text materials 1010 based on the interests and needs of the learner. Lexical items likely unknown to the learner are identified by the text material program or module 1020. Likely unknown items are either removed or substituted with known words obtained from a database of recognized words 122 such that the resulting modified text material 1030 that is generated by the program 1020 is regulated in terms of comprehension to include any desired percentage of known lexical items. This method accordingly allows creation and presentation of pedagogically appropriate reading, listening and video materials to any given learner (e.g., via the user interface 140) in any given language or sub-domain.

FIG. 11A is a display diagram illustrating an example of English language text filtered in accordance with a particular individual's assessed lexical ability in accordance with an embodiment of the invention. More specifically, FIG. 11A illustrates a sample of reading material filtered based on an individual's assessed lexical ability of 1.32. In this example, a comprehension target of 95 percent recognition has been set. Based on the two settings, all of the words that are likely unrecognizable to the user have been identified and, for purposes of this explanation, displayed in bold, italic typeface.

FIG. 11B is a display diagram illustrating the text 1110 of FIG. 11A, after further processing. More specifically, the sample reading material 1110 illustrated in FIG. 11B has been further edited and reconformed such that at least 95 percent of the words remaining in the text will likely be recognizable to the reader and less than 5 percent of the words remaining in the text will likely be unrecognizable to the reader. As much as possible, the process prioritizes the inclusion of unrecognized words in accordance to the user's personal language learning sequence. For purposes of understanding this explanation, various editing marks are left displayed in the illustration.

FIG. 11C is a display diagram illustrating the text 1100 of FIGS. 11A and 11B after the ability-appropriate filtering and editing has been completed. The resulting text is pedagogically ability-appropriate topical reading material that is organized at greater than 95 percent comprehensibility for the learner based on the learner's assessed lexical ability. For purposes of this explanation, the learner's unrecognizable words (less than 5 percent) are displayed in bold, italic typeface.

C. Suitable Computing Systems

FIGS. 12-13B and the following discussion provide a brief, general description of suitable computing environments in which aspects of the invention can be implemented, although it need not be implemented in a computing system. Thus, although not required, aspects and embodiments of the invention can be implemented in the general context of computer-executable instructions, such as routines executed by a general-purpose computer, e.g., a server or personal computer. I hose skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 12, one embodiment of the invention employs a computer 1200, such as a personal computer or workstation, having one or more processors 1201 coupled to one or more user input devices 1202 and data storage devices 1204. The computer is also coupled to at least one output device such as a display device 1206 and one or more optional additional output devices 1208 (e.g., printer, plotter, speakers, tactile or olfactory output devices, etc.). The computer may be coupled to external computers, such as via an optional network connection 1210, a wireless transceiver 1212, or both.

The input devices 1202 may include a keyboard and/or a pointing device such as a mouse. Other input devices are possible such as a microphone, joystick, pen, game pad, scanner, digital camera, video camera, and the like. The data storage devices 1204 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 12).

Aspects of the invention may also be practiced in a variety of other computing environments. For example, referring to FIG. 13A, a distributed computing environment with a web interface includes one or more user computers 1302 in a system 1300 are shown, each of which includes a browser program module 1304 that permits the computer to access and exchange data with the Internet 1306, including web sites within the World Wide Web portion of the Internet. The user computers may be substantially similar to the computer described above with respect to FIG. 12. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 1308, coupled to the Internet or World Wide Web (“Web”) 1306, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 1310 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 1308 may include a server engine 1312, a web page management component 1314, a content management component 1316 and a database management component 1318. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data such as video, graphics and audio signals.

Referring to FIG. 13B, an alternative embodiment to the system 1300 is shown as a system 1350. The system 1350 is substantially similar to the system 1300, but includes more than one server computer (shown as server computers 1, 2, . . . J). A load balancing system 1352 balances load on the several server computers. Load balancing is a technique well-known in the art for distributing the processing load between two or more computers, to thereby more efficiently process instructions and route data. Such a load balancer can distribute message traffic, particularly during peak traffic times.

A distributed file system 1354 couples the web servers to several databases (shown as databases 1, 2 . . . K). A distributed file system is a type of file system in which the file system itself manages and transparently locates pieces of information (e.g., content pages) from remote files or databases and distributed files across the network, such as a LAN. The distributed file system also manages read and write functions to the databases.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the data collection and processing system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, a number of aspects of the invention may be embodied in a computer-readable medium. Accordingly, the inventors reserve the right to add additional claims after filing the application to pursue such additional claim forms for other aspects of the invention.

I/we claim:

1. A language training system, comprising:
one or more set and subsets databases for storing multiple vocabulary items;
an item frequency database for storing multiple vocabulary items from the one or more corresponding set and subsets databases, wherein the multiple vocabulary items in the item importance database are ranked in order of frequency of occurrence within the selected sets and/or corresponding subsets;
a user testing component configured to—
(a) present a series of vocabulary items from the one or more set and subsets to a user for response, and
(b) receive and process user input related to the presented vocabulary items;
a calibration component configured to determine, for each vocabulary item—
a vocabulary item recognizability measure,
a vocabulary item depth of knowledge measure, and
a vocabulary item retention measure,
as compared with users within one or more demographic segments or populations; and
a learning sequence compiler configured to generate, for each user, a target list of unknown vocabulary items.

2. The language training system of claim 1 wherein the learning sequence compiler generates the target list for a particular user based, at least in part, on:
the vocabulary item importance data within a particular set or subset thereof;
a vocabulary recognition ability level of the user;
a vocabulary depth of knowledge abilities of the user; and
a vocabulary retention abilities of the user.

3. The language training system of claim 1 wherein the target list is sorted by ranking the frequency of occurrence of the unknown vocabulary items within the particular set or subset.

4. The language training system of claim 1 wherein the user testing component includes a computer-adaptive testing system configured to present Yes/No and multiple choice decision-type questions for each vocabulary item to the user.

5. The language training system of claim 1 wherein the multiple vocabulary items in the item frequency database are further ranked in order of recognizability within one or more demographic segments or populations.

6. The language training system of claim 1, further comprising one or more learning programs or activities configured to present one or more vocabulary items to each user for response, wherein the one or more vocabulary items are selected based, at least in part, on the generated target list of the user.

7. The language training system of claim 6, further comprising:
a feedback component configured to—
process input based on the interaction between the user and the one or more learning programs or activities; and
deliver the input to the learning sequence compiler;
and wherein the learning sequence compiler is configured to generate an updated target list for the user based, at least in part, on the input from the feedback component.

8. The language training system of claim 6 wherein the one or more learning programs include learning programs accessible via a personal computer, mobile communication device, or other electronic device.

9. The language training system of claim 1 wherein the calibration component is further configured to calculate a vocabulary item recognition ogive for one or more demographic segments or populations using item response theory.

10. The language training system of claim 1, further comprising a communication component configured to deliver target lists or portions thereof to corresponding users via electronic messaging at one or more predetermined intervals.

11. One or more computer memories storing a computer-implemented method for language assessment and instruction, the method comprising:
determining a lexical recognition ability level of a user within a lexicon of a particular language or sub-domain thereof;
based on the recognition ability level of the user, creating a target list of unknown lexical items, the target list being sorted by ranking the importance of the unknown lexical items within the particular lexicon; and
generating a personal language learning sequence for the user based, at least in part, on the target list.

12. The method of claim 11 wherein generating a personal language learning sequence for the user comprises—
determining the importance of each particular lexical item within a corpus or sub-domain of the lexicon;
determining a cumulative lexical recognition ogive for one or more demographic segments or populations related to the user;
determining one or more cumulative lexical depth of knowledge ogives for one or more demographic segments or populations related to the user;
determining a cumulative lexical retention ogive for one or more demographic segments or populations related to the user;
determining the lexical recognition ability level of the user for a language or sub-domain thereof;
determining lexical depth of knowledge abilities of the user; and
determining lexical retention abilities of the user.

13. The method of claim 11 wherein determining a lexical recognition ability level of a user comprises:
presenting a series of real lexical items and pseudo-lexical items to the user for identification, wherein the pseudo-lexical items include false lexical items used for conjecturing error correction; and
processing responses from the user to determine (a) the lexical items identified as known by the user, and (b) the lexical items identified as unknown by the user.

14. The method of claim 13, further comprising:
storing in a database one or more of—
demographic information of the user;
each real lexical item and pseudo-lexical item presented for identification; and
each user response to the presented lexical items; and
aggregating the stored user data with data from other users to determine a standard recognizability factor for each lexical item relative to one or more specific demographic segments or populations.

15. The method of claim 11 wherein determining a lexical recognition ability level of a user comprises:
(a) presenting a first lexical item to the user for identification, the first lexical item being selected from a group of lexical items having recognizability at a predetermined level for the demographic segment of the user;
(b) based on the user response, presenting a second lexical item to the user for identification, the second lexical item having recognizability at a set level above or below the predetermined level;
(c) presenting subsequent lexical items to the user for identification, the subsequent lexical items being selected by statistically determining a selection of one or more additional lexical items having more and/or less recognizability compared to the estimated ability of the user, and wherein pseudo-lexical items are randomly dispersed within the presentation of real lexical items to control for the individual conjecturing behavior of a user; and
(d) repeating steps (b) and (c) until the user has identified as being recognized at least one real lexical item, and also has identified at least one real lexical item as being unrecognized.

16. The method of claim 11, further comprising determining a lexical depth of knowledge ability of the user by—
(a) presenting a first lexical depth of knowledge query selected from a series of depth of knowledge queries at an estimated depth of knowledge ability level of the user, wherein the estimated depth of knowledge ability is based on the assessed recognition ability level of the user;
(b) processing a response to the first query from the user to statistically determine a revised estimated depth of knowledge ability of the user;
(c) presenting one or more subsequent depth of knowledge queries to the user, the one or more subsequent queries being selected based on the revised estimated depth of knowledge ability; and
(d) repeating steps (b) and (c) until the lexical depth of knowledge ability of the user is determined within a desired degree of accuracy.

17. The method of claim 11 wherein the lexical items comprise symbols, multi-symbol units, sounds, utterances, words, multi-word units, or idiomatic expressions that have particular meaning within the lexicon.

18. The method of claim 11 wherein the target list includes the next most important set of words to be learned within the particular lexicon.

19. The method of claim 11, further comprising:
repeating determining a lexical recognition ability level of the user and creating a target list of unknown lexical items based on the item recognition ability level at multiple testing periods; and
updating the language learning sequence of the user based, at least in part, on the results from one or more testing periods.

20. The method of claim 11, further comprising generating text materials for the user based, at least in part, on the lexical abilities of the user, wherein the text materials can include reading, listening, and video materials.

21. The method of claim 11, further comprising filtering the text materials before presenting the text materials to the user, wherein a set target percentage of the lexical items in the filtered text materials can be predetermined.

22. The method of claim 11, further comprising delivering the language learning sequence or a portion thereof to the user via electronic messaging at one or more predetermined intervals.

23. The method of claim 11, further comprising generating one or more reports based on the language learning sequence, the one or more reports including any one or more of the following:
graphical and textual descriptions of the lexical items known by the user;
number of known and unknown lexical items to the user within a corpus or sub-domain of the lexicon;
identification of each unknown lexical item;
number of known and unknown lexical items within different importance bands or frequency bands of a corpus or sub-domain of the lexicon;
depth of knowledge ability of the user for the items in the lexicon;
retention ability of the user for the items in the lexicon;
learning rate of the user based on interactions with one or more learning programs; and
comparison between any particular reported user or group attribute and equivalent attributes of one or more desired groups, demographic segments or populations.

24. A language instruction system, comprising:
means for storing multiple lexical items within a corpus or corresponding sub-domains;
means for ranking the multiple lexical items in order of importance within the corpus and/or corresponding sub-domain;
means for receiving and processing user input in response to a presentation of at least a portion of the multiple lexical items to each user for response;
means for calculating, for each user, a lexical recognition ability measure, lexical depth of knowledge measures, and a lexical retention measures as compared with other users within a given demographic segment or population; and
means for generating a target list of unknown lexical items for each user.

25. A system for semantic knowledge assessment and instruction, the system including an item importance database for storing multiple lexical items, wherein the stored multiple lexical items are ranked in order of importance within a selected corpus and/or corresponding sub-domain, the system comprising:
a computer-adaptive testing component configured to—
present a series of lexical items from the selected corpus and/or sub-domain to a user for identification; and
receive and process user input for each presented lexical item;
a calibration component configured to determine, for each user—
a lexical recognition ability level,
multiple lexical item depth of knowledge measures, and
multiple lexical item retention measures,
as compared with users within one or more demographic segments or populations; and
a learning sequence compiler configured to generate, for each user, personal language learning sequence including one or more unknown lexical items, the selected lexical items being organized by priority of item to be learned in sequence within the particular corpus and/or sub-domain.
